(19) United States
(12) Patent Application Publication
(10) Pub. No.: US 2003/0105858 A1
(43) Pub. Date: Jun. 5, 2003

(54) Method and apparatus for remote database maintenance and access

(76) Inventors: John Hogg, Vancouver (CA); Lorne Churchill, Abbotsford (CA); Chris Howerton, Langley (CA); Lee Purvis, Langley (CA); Randall Venhola, Chilliwack (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/026,932

(22) Filed: Dec. 27, 2001

(30) Foreign Application Priority Data
Dec. 29, 2000 (CA) 2,329,891

(51) Int. Cl. G06F 15/173

(52) U.S. Cl. 709/224

(57) ABSTRACT

A distributed application has a client software component on a client computer which communicates with server software on a server computer by way of a remote procedure call (RPC) system. The server has a persistent memory manager which keeps data available in high-speed memory and periodically backs up the data to disk or other lower-speed memory. Keeping transactions short and synchronous permits the entire database to be locked during each transaction. The system can provide responsiveness and usability approaching that of a stand-alone application.

### TECHNICAL FIELD

This invention relates to the fields of databases, distributed computing systems, and client server computing. More specifically, this invention teaches methods and apparatus for managing a database within a distributed computing environment. The invention has application in the management of server-resident databases from client computers which are connected to servers by way of a communication channel that is not reliably fast. The invention has specific application to interactive transaction processing over wide area networks such as the internet.

### BACKGROUND

The internet is making possible collaboration between distributed groups of computer users in many fields. In many such fields it is desirable to provide a common repository of information which can be maintained and accessed by users at remote locations. In the current state of the art, this can be done by providing a server computer running a database management system such as ORACLE™ or SQL SERVER™ and an active web server. Users who wish to be able to retrieve data from the database or take part in managing the database have internet-connected computers running web browsers. The users access web pages hosted at the web server. The web pages provide interfaces by way of which the users can obtain data from or maintain the database. Data is most typically communicated between the user's computer and the server computer by way of the hypertext transfer protocol (HTTP).

A main problem with the current state of the art is that access to databases can be unacceptably slow. General wisdom is that a web page must be available on a user's computer within 8 seconds. Many users will give up before waiting more than 8 seconds for a web page to load. This problem is exacerbated because many users connect to the internet using relatively slow modems. Web pages can contain large amounts of data. With current technology it is very challenging to provide a database accessible by way of a web interface which will meet even this low performance standard. In fact, users require applications to be much more responsive than this. Even waiting for a few seconds for a web page to load or update can be very frustrating for users. Research studies have established that sub-one second response time is a requirement for high productivity and an agreeable user experience.

Other methods for allowing interaction between users at user computers and servers use the Common Object Request Broker Architecture (CORBA) specification. CORBA defines a standard interface by way of which distributed objects which comply with standards set by the Object Management Group (OMG), an association of computing industry companies, can communicate with one another. The CORBA interface is unnecessarily complicated for many applications and does not guarantee faster performance than web-based interfaces.

Some existing RPC systems, such as ONC RPC, are too low level to use conveniently. These RPC systems do not support one or more of: exceptions, encryption, compression, or object parameters.

Some high-performance hardware/software systems for providing distributed applications are available but these are often prohibitively expensive.

There is a need for methods and systems for providing interactive online transaction processing which are much faster than currently used systems.

### SUMMARY OF THE INVENTION

This invention provides methods and apparatus useful for making data available to users of network-connected user computer systems. One aspect of the invention provides a method for generating a report at a client computer based on data resident at a server computer. The method comprises, at a client computer: obtaining from a server computer by way of a remote procedure call a list of items to be included in a report, the list including a reference associated with each of the items; for each of the items in the list, generating a request for data associated with the item, the request including the reference associated with the item; forwarding the request to the server computer by way of a remote procedure call; receiving from the server computer the requested data associated with the item; after receiving the requested data serially requesting and obtaining data corresponding to subsequent items in the list; and, rendering a report based on the requested data.

Another aspect of the invention provides a method for making data available to users at a plurality of distributed network-connected user computer systems. The method comprises maintaining entirely in a high-speed memory of a server computer a data store comprising a data heap containing a number of data and a data reference vector comprising a plurality of records, each record corresponding to a datum in the data heap; receiving at the server computer a request for data, the request comprising a reference corresponding to a record in the data reference vector; locking the data store; based on the record in the data reference vector corresponding to the reference, retrieving the requested data from the data store; unlocking the data store; and, forwarding the requested data to a client computer system.

A further aspect of the invention provides a method for making data available to users at a plurality of distributed network-connected user computer systems. The method comprises: maintaining entirely in a high-speed memory of a server computer a data store; establishing a remote procedure call connection between the server computer and a client computer; receiving by way of the remote procedure call connection a request for data from the data store; locking the data store; based on the request, retrieving the requested data from the data store; unlocking the data store; and, forwarding the requested data to the client computer system by way of the remote procedure call connection. The high-speed memory may be RAM or memory which provides performance equivalent to RAM.

Additional aspects of the invention provide a computer programmed to implement a method according to the invention; a program product comprising a medium carrying computer-readable signals, the signals comprising instructions which, when executed by a computer processor cause the computer processor to execute a method according to the invention; and a memory-resident data structure as described below.

Further features and advantages of the invention are described below.

### BRIEF DESCRIPTION OF THE DRAWINGS

In figures which illustrate non-limiting embodiments of the invention:

FIG. 1 is a network diagram illustrating a computer network on which the invention may be practised;

FIG. 2 is a schematic diagram illustrating locations of main software components that may be used in practising the invention;

FIG. 3 is a schematic diagram illustrating the allocation of memory to a data store in a server computer;

FIGS. 4A and 4B are respectively diagrams illustrating the components of internal and external references to data in a data store as used in a preferred embodiment of the invention;

FIG. 5 illustrates a data reference vector;

FIG. 6 is a process chart which illustrates the use of a data model language compiler;

FIG. 7 illustrates a request or reply message according to the invention;

FIG. 8 is a schematic overview illustrating services which may be provided in a system according to the invention; and,

FIG. 9 is a structure of client-side and server-side components in one possible implementation of the invention.

### LIST OF REFERENCE NUMERALS

| | | | |
|---|---|---|---|
| 10 | system | 12 | user computer |
| 14 | network | 20 | server |
| 22 | software client component | 22A | user interface |
| 22B | client kernel | 22C | client software installer |
| 26 | RPC system | 26A | client-side RPC component |
| 26B | server-side RPC component | 27A | server-side TCP/IP |
| 27B | RPC function dispatcher | 27C | RPC server stubs |
| 27D | client-side TCP/IP | 27E | RPC client stubs |
| 30 | software server component | 32 | persistent memory manager |
| 33 | business logic layer | 34 | operating system |
| 36 | data store | 36A | data heap |
| 36B | data reference vector area | 37 | data reference vector |
| 38 | reference vector record | 38A | memory reference |
| 38B | data kind value | 38C | uniqueness value |
| 38D | change value | 39 | operating memory |
| 40 | disk storage | 43 | internal reference |
| 44 | external reference | 44A | internal reference part of |
| | | | external reference |
| 44B | data kind value | 44C | uniqueness value |
| 44D | change value | 50 | DML compiler |
| 52 | DML source | 54 | header file |
| 56 | text file | 58 | graphic display tool |
| 59 | graphic overview | 62 | configuration server |
| 64 | log server | 71 | connection service |
| 72 | directory service | 73 | data and management service |
| 74 | data server registration | 75 | log service |
| | service | | |
| 76 | log server registration | 77 | log service |
| | service | | |
| 78 | find log server service | 79 | authorization manager |
| | | | service |

Description

This invention provides a transaction processing system. The invention may be used to maintain a central database from a number of distributed locations. The invention includes a number of components which are used together in the currently preferred embodiment of the invention but may also have individual application in other contexts.

1. Overview

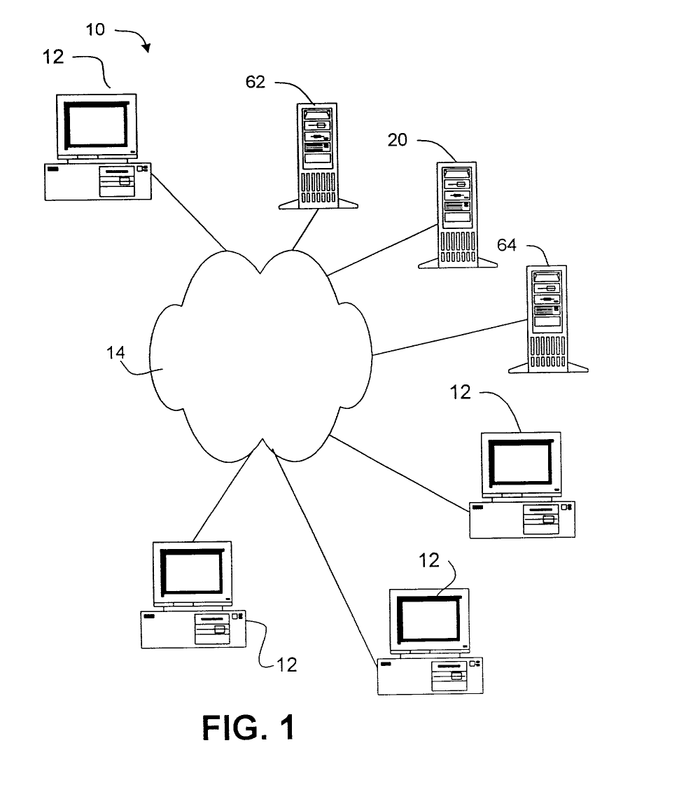

FIG. 1 shows a computer network in which the invention may be applied. A plurality of user computers 12 are connected to a server 20 by a network 14. Network 14 may be the internet, a wide area computer network, or the like. The users of computers 12 each require the ability to access and maintain a database hosted on server 20.

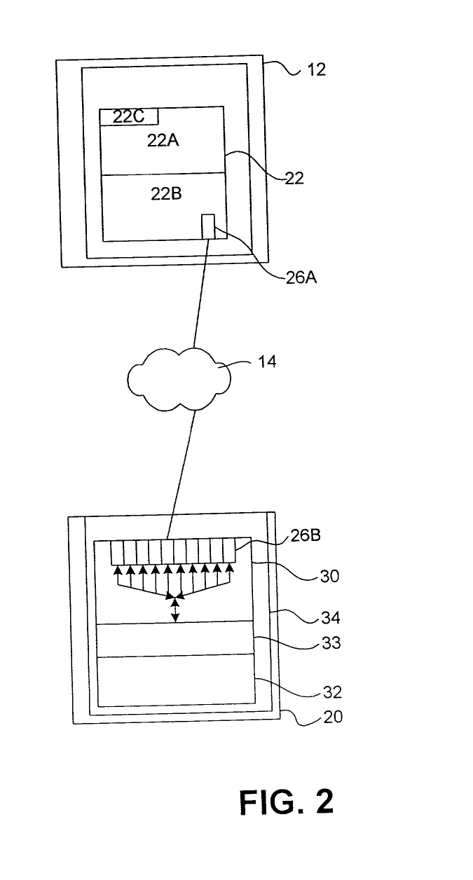

As shown in FIG. 2, a system according to the invention has three major software-based components, client components 22 which run on user computers 12, a server component 30 and a remote procedure call (RPC) system 26 for maintaining communications between client components 22 and server component 30 over network 14. Server component 30 includes a persistent memory manager 32, and a business logic layer 33 which run on server computer 20. RPC system 26 includes a client-side components 26A located at user computer 12 and server-side RPC components 26B located at server computer 30. It has been found that a system having this architecture can provide surprising responsiveness.

FIG. 9 shows a more detailed structure for a possible implementation of client-side RPC components 26A and server-side RPC components 26B. In the implementation of FIG. 9, server-side RPC components 26B comprise a RPC server side TCP/IP connection 27A, a RPC function dispatcher 27B and RPC server stubs 27C. Client-side RPC components 26A comprise a RPC client side TCP/IP connection 27D and RPC client stubs 27E.

Client component 22 may take various forms. Preferably client component 22 is a “thin client”. That is, in general, it is preferred that server component 30 performs as much manipulation of data as possible. Client 22 preferably performs only the minimum amount of processing required to map user interface actions to requests for processing by server component 30 and to receive from server component 30 and display to a user resulting data. A user can perform data entry and manipulate data from client component 22.

In a currently preferred embodiment of the invention, client component 22 comprises a client graphical user interface (GUI) 22A, a client kernel 22B and a client installer 22C. A user can obtain client component 22 in various ways. Typically a user will obtain a program product comprising a medium which carries client component 22 in the form of a set of computer-readable signals. The program product may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links.

For example, a user may download one or more files containing client component 22 from an internet web site or ftp site or by obtaining a physical program product comprising a computer-readable storage medium on which the computer instructions which make up client component 22 are written. Upon receiving the program product the user can run client installer 22C on a user computer 12. When it is run, client installer 22C causes the processor of user computer 12 to install client GUI 22A and client kernel 22B for use on user computer 12.

Client GUI 22A contains code and resources to manage the appearance of the interface with users. Client GUI 22A may, for example, be written in the JAVA programming language and be run on a JAVA virtual machine provided in user computer 12. Client kernel 22B contains code which implements functions required by client software 22. For example, client kernel 22B may include the client-side RPC component portion 26A of RPC system 26 as well as a report module and functions for handling the operation of any more complex controls displayed by client GUI 22A.

RPC system 26 permits client software 22 to access functions supplied by server components 30 running on server 20 by implementing local function calls on user computer 12. Each user computer 12 has a client-side RPC component 26A which provides an interface to the RPC system 26. Server 20 preferably has a separate server-side RPC component 26B for every active connection with a client-side interface 26A. Preferably, server 20 runs a multi-threaded operating system 34. Operating system 34 provides a separate thread for each server-side RPC component 26B. Operating system 34 may, for example, be a UNIX type operating system such as LINUX. Where it is expected that server 30 will be accessed concurrently by a large number of users then it may be desirable or necessary to tune and reconfigure operating system 34 from its default configuration. In the case of LINUX, for example, there are kernel patches available which significantly improve performance when the number of concurrently pending threads exceeds about 103.

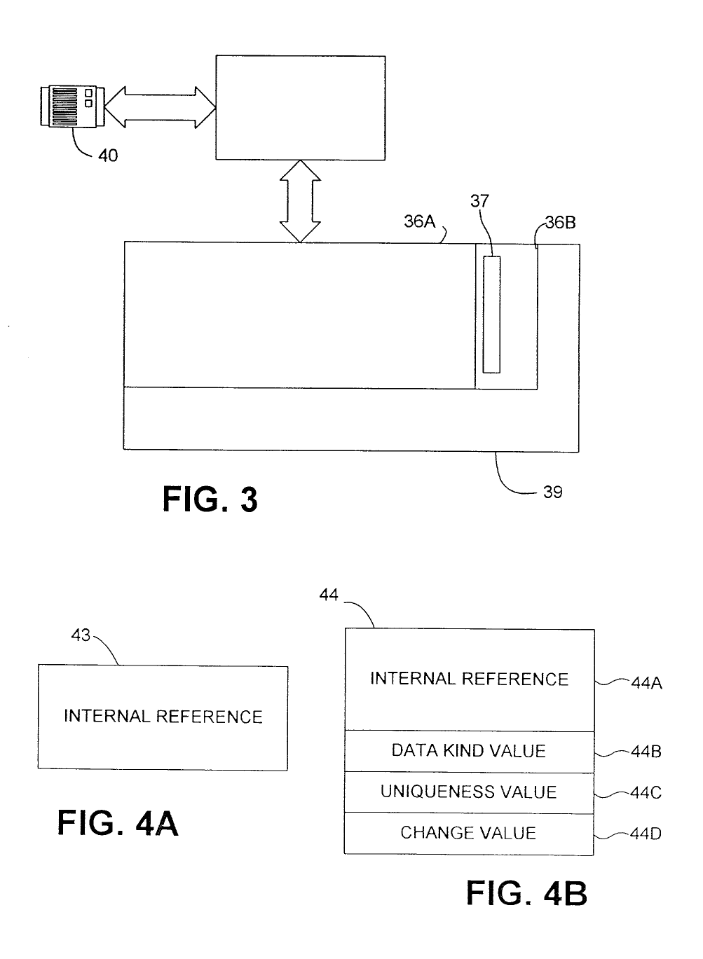

Persistent memory manager 32 manages a store 36 which contains data. A single server 20 may host multiple data stores 36. As shown in FIG. 3, each data store 36 preferably resides entirely in high speed operating memory 39 of server computer 30 (as opposed to a slow disk drive or other slow storage device). In the preferred embodiment of the invention data store 36 comprises two contiguous memory areas, a data heap 36A and a data vector reference area 36B. Data vector reference area 36B contains data structures that persistent memory manager 32 uses to identify and manage data in data heap 36A. Data heap 36A contains the actual data.

Persistent Memory Manager

One way in which preferred embodiments of this invention attain high performance is to keep all data readily accessible in high-speed operating memory 39. RAM can now be obtained reasonably inexpensively. It is readily possible to provide server computer 20 with sufficient RAM to contain even a reasonably large data store 36 entirely in operating memory. For example, server computer 20 may have 1 to 2 gigabytes, or more, of RAM. As noted above, data store 36 is managed by persistent memory manager 32.

Persistent memory manager 32 causes a computer processor 41 to back up the contents of data store 36 to a suitable persistent storage medium such as a disk drive 40. This occurs periodically, for example, once per minute. This rate of backing up data is acceptable for many applications in which the rate at which data in data store 36 can change is limited by the speed at which connected users can enter data. In the preferred embodiment, each back up operation comprises writing the set of changes to the data since the last backup operation to disk 40 as a single file. Data backup may be performed by a background thread in persistent memory manager 32 which wakes up periodically to see if there are data changes to be written to disk. For many applications, the data change rate is limited to the typing speed of its users. Therefore, the amount of data that the background thread writes to disk 40 will typically be very small, and its interference with normal transactions will be imperceptible.

Periodically, persistent memory manager 32 performs a full save in which it writes the entire data store 36 to disk 40 as a single file. When it is necessary for persistent memory manager 32 to restore the state of data store 36 from disk 40, persistent memory manager 32 opens an existing store, finds the most recent full save and incrementally applies all more recent change files to that base. Backed up data on disk 40 consists of a set of ordinary files which can be further backed up to a tape drive, CD-ROM or other backup system using any suitable backup method.

Persistent memory manager 32 preferably meets the following requirements:

It maintains references to data in data store 36 that can be used by external processes (for example, client software 22). These references should remain valid after data store 36 has been restored from disk. In general, one cannot assume that a particular data item will stay in the same location in operating memory 39. An item may be moved as a result of memory reallocation and garbage collection, restoring a data store 36 from disk 40, a string being made longer, or the like. Persistent memory manager 32 cannot index data in data store 36 with a simple set of pointers to locations in operating memory 39.

It should implement data locking so that a data store 36 can be used concurrently by multiple users.

It should provide a mechanism for indicating when data corresponding to a datum reference has been changed or deleted since the last time a user used the datum reference. This is because in the preferred embodiment of the invention, persistent memory manager 32 exports datum references and supports concurrent use by many users.

It is desirable that the persistent memory manager 32 supports mechanisms that promote reliability by helping to discover design and implementation errors, both in the software code that makes up persistent memory manager 32 itself and in software code that uses persistent memory manager 32. The mechanisms supported should be economical, both in terms of implementation costs and in run-time costs.

Preferably persistent memory manager 32 is written using programming languages and techniques that facilitate porting persistent memory manager 32 among a variety of computer operating systems.

Persistent memory manager 32 uses the memory allocation services of host operating system 34 to allocate memory for its use. This may be done, for example by calling the C library functions malloc and free. For simplicity and speed in the disk save and restore processes, each of areas 36A and 36B is a block of contiguous memory locations. This is also a significant contributor to memory efficiency. Using system memory allocation for each datum would add overhead in both space and time.

Persistent memory manager 32 preferably supports simple data typing. This permits persistent memory manager 32 to provide a data type checking facility at a low implementation and performance cost. The data type checking facility can detect and help to prevent some possible errors in the code which uses the services or persistent memory manager 32.

A currently preferred embodiment of the persistent memory manager 32 is written in the C++ programming language. In this embodiment, persistent memory manager 32 supports two basic data types, structs and strings, and one aggregate data type, vectors of structs. A struct is a fixed-length block of storage. A struct can contain any sort of fixed-length data such as one or more integers, characters, boolean values, fixed-length arrays of such data types, and so on.

The data type checking facility operates on type values which are assigned to each struct. The type value may be a small integer, for example. The type value is used to help the calling software detect possible errors in referring to data in the store.

In the preferred embodiment, persistent memory manager 32 can deal with vectors of structs. Persistent memory manager 32 includes service routines to allocate, store, fetch, and delete such vectors. Related collections of structs can, of course, be managed by stringing them together into lists, but there are many cases in which vectors are more space efficient and natural ways to represent struct collections.

Character strings are used a great deal in many applications. The lengths of character strings can vary dramatically. For these reasons, it is generally useful to provide special support for character strings in persistent memory manager 32.

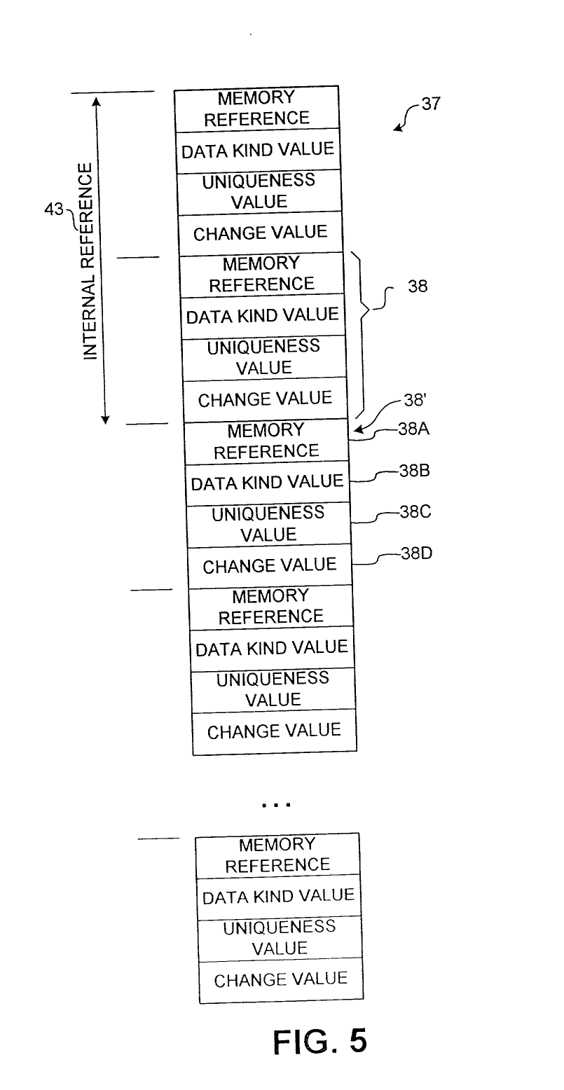

In the preferred embodiment of the invention a data reference vector 37 resides in data reference vector area 36B. As shown in FIG. 5, data reference vector 37 comprises a plurality of records 38 which each include a pointer 38A to a datum resident in data heap 36B.

Persistent memory manager 32 preferably maintains two types of data references. Internal data references 43 (FIG. 4A) and external data references 44 (FIG. 4B). Internal references are used internally by server-side software 30. Internal references 43 can simply comprise a number which provides an index to the record 38 in data reference vector 37 corresponding to the datum being referenced. Further information is not required since the type and size of the referenced data is known to the server. Since internal references are used while data store 36 is locked, as described below, data will not be changed or deleted by any other thread. In the currently preferred embodiment of the invention, an internal data reference is an unsigned 32 bit integer. Zero is a special value semantically equivalent to a null pointer.

Eternal data references are used externally to server 20. For example, client-side software 22 uses external references to identify data in data store 36. External data references preferably carry enough information to identify situations in which the external references become corrupted and situations in which the data to which they refer has changed or been deleted from data structure 36. An external reference preferably comprises: an internal reference, a “uniqueness” value; a change value, and a data kind value. The data kind value allows persistent memory manager 32 to provide simple type checking when external references are used to fetch, modify, or delete data. The uniqueness and change values can be used to reduce the likelihood that client actions will be based on an out of date understanding of the state of data in data store 36.

In the interest of simplicity and space efficiency, persistent memory manager 32 makes validity checks which offer assurances that are highly likely rather than certain. Whenever data is stored, fetched, or deleted using an external reference 44, persistent memory manager 32 compares the data kind value 44B in the external reference to the data type 38B of the data in data store 36 which is referenced by the internal reference 44A of the external reference. The operation fails if the data kind value 44B does not match the data type 38B.

Another check that persistent memory manager 32 may perform is a uniqueness value check. Internal references may be reused. It is possible that, between the time an external reference 44 was created for a datum identified by the internal reference 44A and the time a client uses it to reference the datum, another user might have deleted the datum. Persistent memory manager 32 may then reuse the internal reference 44A to identify a new datum of the same type. This could result in the client receiving access to a datum that no longer exists. Incorrect behaviour could result. To prevent this, the uniqueness value 38C in a data reference vector entry 38 is incremented each time the entry is reused. A uniqueness value 44C is included in each external reference 44. When persistent memory manager 32 is required to look up the datum corresponding to an external reference it checks to see whether the uniqueness value 44C of the external reference matches the corresponding uniqueness value 38C in data reference vector 37. If these values do not match then the operation fails.

The uniqueness value may be, for example, a 16 bit unsigned integer. If so, it is possible for an invalid reference to escape this check if an entry has been reused an exact multiple of 65,536 times. This is not impossible, but it is extremely unlikely.

Another check that persistent memory manager 32 may perform is a change value check. Each time a datum is changed, an associated change value 38D in reference vector 37 is incremented. When it receives a request for a datum identified by an external reference 44, persistent memory manager 32 compares change value 44D to the change value 38D in reference vector 37. If these change values do not match then the check fails. The change value may be, for example, an unsigned 8 bit integer. If so then this check may fail to detect a change if the datum has been changed an exact multiple of 256 times since the external reference 44 was provided to the client. This is unlikely. A smaller integer may be used for change value 44D than is used for uniqueness value 44C. One can accept a higher likelihood of failure on the grounds that the failure of a change value check is typically much less serious in its potential consequences than is the failure of a uniqueness value check.

The foregoing checks can be applied to manage data conflicts which may occur as a result of data store 36 being managed concurrently by a number of users. In particular, persistent memory manager 32 can use these checks to detect changes and deletions that occur between the time an external data reference 44 is provided to an instance of client software component 22 and the time at which the client software 22 attempts to use the external reference 44 to access data in data store 36.

Change conflicts (which result from intervening changes to data) may be detected in most cases by performing a change value check, as described above. It is not necessary to perform this check in every case because there are many cases where the change value is irrelevant. For instance, if client software 22 is requesting data for the first time from that reference, it will not matter if the data has changed since the reference was acquired. In such cases, persistent memory manager 32 can simply return to the client software 22 the current value of the data corresponding to the external reference.

Delete conflicts occur in cases where an external reference 44 refers to a datum which was present in data store 36 when the external reference was generated but has since been deleted from data store 36. Persistent memory manager 32 should create an error signal (i.e. an appropriate exception) when this occurs. Client software 22 can then deliver a suitable error message by way of interface 22A and can update its local state appropriately. For instance, client software 22 may be displaying a list of people and may issue a request for data regarding one of the people. If server 20 returns an exception which indicates that the record for that person has been deleted from data store 36 then client software 22 should remove that person from the display list and display a suitable error message.

Because changes and deletions can be identified at the datum level rather than, for example, the table level, a system according to this preferred embodiment of the invention can frequently present more meaningful error dialogues than can a system which monitors changes at a coarser level. In some cases, conflict detection at the datum means that such conflicts can be avoided altogether.

Entries in data reference vector 37 can be recycled, but should not be moved (the entries may be referred to externally by various indices). This makes space management in data reference vector 37 very simple. Data in data heap 36A can be moved, however. Persistent memory manager 32 reclaims space which was occupied by deleted data by running a suitable garbage collection routine. The garbage collection routine may, for example, implement a mark and sweep method of garbage collection. The garbage collection routine may be run periodically. Preferably the garbage collection routine is triggered when predetermined trigger criteria are satisfied. The trigger criteria may include an amount of space available from garbage collection, together with an elapsed time measure since the garbage collection routine was last run.

In the preferred embodiment of the invention, Persistent memory manager 32 is implemented as a C++ class. One instantiation of the class manages one data store 36. Persistent memory manager 32 provides methods for creating data, modifying data, deleting data and retrieving data. In addition, persistent memory manager 32 provides initialization methods which run on initialization. One initialization method executes for new data stores 36 and another for existing data stores 36. The initialization methods specify various attributes of data store 36 including such things as its unique name, unique ID, size, expansion size, save interval, and so on.

The functions for retrieving data from data store 36 perferably operate differently on structs than they do on strings. Functions for retrieving structs move a copy of the requested struct from data store 36 to storage allocated by business logic layer 33. Functions for retrieving strings move a copy of the requested string to storage allocated by persistent memory manager 32.

In normal operation, business logic layer 33 maintains indices which make it unnecessary to iterate through the data in the a data store 36. However, it can be preferable to build the indices at the time a data store 36 is being opened. Preferably persistent memory manager 32 provides a scanning function which can be invoked to scan the contents of a data store 32 for the purpose of finding all data of given types. The scanning function can be invoked repeatedly to obtain the required information to build indices of the data in a data store 36.

There is a need for a mechanism to prevent data store 36 from being altered by one function while another function is accessing data from data store 36. In the preferred embodiment of the invention, persistent memory manager 32 has two functions that support mutual exclusion for access to data in data store 36. A lock function locks all of the data in data store 36. An unlock function unlocks the data. After persistent memory manager 32 is initialized (i.e. after the appropriate initialization method is completed) all subsequent calls to persistent memory manager methods must be made while persistent memory manager 32 has data store 36 locked. It is the caller's responsibility to ensure that the data is correctly locked. Only the caller knows when the lock must be imposed.

The caller (usually business logic layer 33) will typically use a series of calls to persistent memory manager functions to implement a logical transaction. Allowing other access to data store 36 while the logical transaction is pending could destroy the integrity and consistency of the data. The lock and unlock functions can also be invoked by the background thread of persistent memory manager 32 before and after saving the contents of data store 36 to disk.

Where business logic layer 33 operates in response to requests made by clients via an RPC system 26, business logic layer 33 will receive a request, call the lock function of persistent memory manager 32, call the transaction function(s) necessary to satisfy the RPC transaction, receive the results of the function(s) and call the unlock function. The calls are preferably contained in a try-catch block so that exceptions can be intercepted and the persistent memory manager 32 can be unlocked should an exception occur.

This locking (mutual exclusion) system has the great virtue of simplicity and efficiency. For this system to work best several instances of persistent memory manager 32 each servicing a different data store 36 should be hosted on the same server computer 20. This enables effective use a server computer 20 which has multiple processors. In cases where a server computer 20 hosts only one instantiation of persistent memory manager 32 there may be times when some processors are idle because only one thread can execute. This may not be an issue if server computer 20 has only a single processor.

The locking system locks the entire data store 36 while each transaction is processed. Therefore transactions should be kept short. “Short” means a fraction of a second. Preferably mean transaction times are a few milliseconds. Preferably maximum transaction times are a few tens of milliseconds, or less.

Persistent memory manager 32 may offer additional functions such as: MakeExternal, a function which converts an internal reference to an external reference; UpdateChange, a function which brings the change value of an external reference up to date; CompactData, a function which triggers the garbage collection routine and minimizes the memory size of data store 36; TimerAction, a method which can be called by the background thread of persistent memory manager 32 to save changes in data store 36 to disk; and SaveToDisk, an explicit method to save the data in data store 36 to disk. SaveToDisk, may be used for testing persistent memory manager 32 or applications which use it.

Those skilled in the art will understand that a persistent memory manager according to the preferred embodiment of the invention is simpler than an object store or a database. This results in a relatively low implementation cost, good storage economy, and good performance.

Business Logic

Business logic layer 33 implements logic in support of the particular application in which the system is being used. Business logic layer 33 maintains any indices necessary for the operation of the system. For example, where the system provides applications for tracking attributes associated with people, business logic layer 33 maintains indices which permit the information associated with specific people to be requested from persistent memory manager 32. It is not necessary for persistent memory manager 32 to directly support the concept of an index. As an alternative to, or in addition to maintaining indices, business logic layer 33 may keep pointers to the origins of lists threaded through the data in data store 36. Any references in data store 36 to other data within data store 36 should reference the other data by way of data reference vector 37 and not by way if a pointer which points directly to the other data. In general, these internal references can be made using internal references 43. It is not necessary to use external references 44.

Preferably memory 39 of server computer 20 is used economically. It will frequently not be economical for business logic layer 33 to replicate data from data store 36 into an external index. Furthermore, having an external copy of data from data store 36 requires that the external copy be kept in synchronization with changes to the data in data store 36. For these reasons, persistent memory manager 36 preferably offers compare functions that support the kinds of store data comparisons sufficient for index maintenance. For example, persistent memory manager 32 may provide functions which compare two strings of structs within data store 36, or compare a string or struct from data store 36 with an external one. Given these compare functions, business logic layer 33 can keep indices which include references to data in data store 36 rather than copies of the data, and can be maintained efficiently.

Implementing a Persistent Memory Manager

Server designers who intend to use a persistent memory manager 32 to manage a data store 36 need to design data structures which are both appropriate to their application and to persistent memory manager 32. The simplest, most basic approach to this problem is to compose C or C++ structs which describe the data storage which goes directly into the PMM. This approach has the drawback that the resulting C or C++ structs are somewhat opaque to the reader because any references to other data in data store 36 are internal references 43. There is no graphical overview of the storage layout. A graphical overview can be very useful in improving understanding, both for the designer and for others. A further disadvantage of this approach is that there are choices to be made by the designer which do not appear directly in a simple struct layout. These choices include things such as the data model name, the persistent memory manager data version number, and the datum kind values used to help run time error checking. It would be useful to have an expression of these choices available in one location.

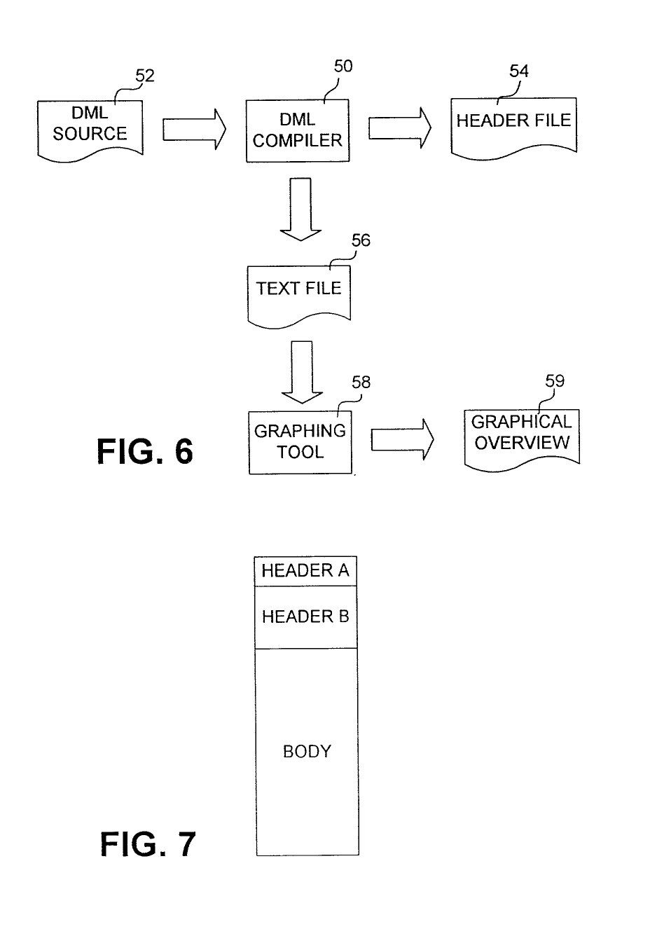

As shown in FIG. 6, a preferred embodiment of the invention provides a persistent memory manager compiler 50 which accepts input (DML source 52) written in a simple persistent memory manager data model language (DML). The use of DML compiler 50 addresses the foregoing disadvantages by providing a simple language which can be used to describe all the relevant attributes of a persistent memory manager data model. Preferably the compiler produces two output files: a header file 54 containing C or C++ struct definitions, and another file 56 which can be used as input to a graphical tool 58 to provide a graphical overview 59 of the storage layout. For example, the second file may be a text file in a format suitable to be used by GRAPHVIZ™ software to produce POSTSCRIPT™ or FRAMEMAKER™ MIF output. GRAPHVIZ software is available from AT&T Labs and is described at the Internet web site http://www.research.att.com/sw/tools/graphviz.

Data Model Language

A preferred embodiment of the data model language permits a programmer to declare a model using the syntax:

model X version N { . . . };

where X is the model name and N is an integer representing the version level of data to be stored in the persistent memory manager 32. The model name becomes the namespace name in the generated header file 54, and the version number will appear in the namespace as a constant. If the model is X and the version is 5, the declaration in the header file 54 will be: const UInt32 XDataVersion=5.

Within the model declaration, the DML permits a programmer to define enumerations (enums) and structs and unions and struct vectors. Enumerations are declared in the usual C way. For example, as follows:

```
enum Alice {
  aliceSmall,
  aliceMedium,
  aliceBig
};
```

DML structs are similar in appearance to C structs, but they are not as general (type restrictions) and they have one syntactic addition (the PMM datum kind value). A struct can be declared, for example, as follows:

struct X N {
. . .
};

where X is the struct type name and N is the PMM datum kind value for this type. Within the struct, a programmer can declare scalars (for example, scalars of the types: UInt8, SInt8, UInt16, SInt16, UInt32, SInt32, RPCDate and bool). DML also permits a programmer to declare enumerations that have been defined and pointers to struct and struct vector types that have been defined.

In the preferred embodiment the a PMM data kind value is specified as a constant because one may wish to change data models over time. The ability to keep datum kind values constant is useful for managing upgrades in a manner which ensures upward compatibility.

Preferably the DML handles strings as special case. Strings are defined only as pointers to strings. The strings themselves are strings that are allocated separately in data store 36. A sample struct definition is as follows:

```
struct Person 42 {
  string* lastname;
  string* firstName;
  RPCDate birth Date
  UInt32 weight;
  CommList* inTouch
  bool inGoodStanding;
};
```

In some cases, a field in a struct will refer to another datum in data store 36 implicitly rather than explicitly. As an example, a programmer might wish to refer to an entry in a struct vector by an integer which is a unique ID assigned to that particular entry in the struct vector. Explicitly, this field is an integer, but implicitly, it refers to the struct vector. The server logic which supports this will know which struct vector to use by context; i.e. where the integer appears. However, this will not be evident to DML compiler 50. As a result, DML compiler 50 may not generate the appropriate link in the graphical representation 59 of the data structure. Preferably DML compiler 50 supports the specification of implicit references in the field declarations. A programmer should be able to include a pointer type in parentheses after the base type in a field declaration. For instance, if the base type is UInt32 but the implicit reference is to a struct vector of type City, the field declaration will look like this:

UInt32 (City*) theCity;

This informs DML compiler 50 that the unsigned integer is an implicit reference to a struct vector of type City so that DML compiler 50 can include appropriate links in text file 56.

Struct vectors may be declared in exactly the same way as structs, except that the keyword structv is used instead of struct. The generated header 54 defines the structure as a simple struct which will be repeated an arbitrary number of times in the vector.

DML permits programmers to declare unions at the top level as is possible in the C programming language. For example:

```
struct Fox 1 {
  . . .
};
struct Weasel 2 {
  . . .
union Beastie {
  Fox* foxRef;
  Weasel* weaselRef;
};
struct LowSlungAnimals 3 {
  bool foxyBeast; // true if fox, false if weasel
  Beastie slinkyBeasts;
};
```

In this example, comments are prefaced by “//” in C++ style.

DML compiler 50 treats pointers in structs that point to the struct in which they are enclosed as list headers. In the graphical output 59 these structs will point to a special cell named “List of X”.

RPC System

As described above, RPC system 26 is designed to provide communication between client software 22 and server software 30. RPC system 26 is designed to be simple. In the preferred embodiment of the invention, the protocol used by RPC system 26 is synchronous. This means that from the point of view of client-side RPC component 26A there is no overlap between RPC transactions: one transaction is completed before another one begins. The underlying TCP/IP data transport mechanism will frequently overlap acknowledgements with data operations, but that is invisible to RPC system 26. Further, the protocol is half-duplex. Client-side RPC component 26A sends a request message (request), server-side RPC component 26B reads the request, creates and sends a reply message (reply) in response to the request and then client-side RPC component 26A reads that reply. This sequence repeats until the session ends.

Preferably requests can be cancelled by software client component 22. Software server component 30 periodically polls the TCP connection (server-side RPC component 26B) for queued data. If it finds any new messages from software client component 22 before it completes sending a reply to a previously-received request message it assumes cancellation of the request, reads the cancellation request (which may be a request for other data), and terminates the send.

The preferred protocol is also client pull. This means that all transactions are initiated from a client computer 12. Server computer 20 does not asynchronously push data to client computers 12. An RPC transaction consists of a client request, followed by the server reply. To invoke a remote function, client kernel 22B makes a call to the client-side RPC component 26A, which includes the client stub. Client-side RPC component 26A packs the call parameters into a request message, and invokes a wire protocol, such as TCP/IP to ship the message to server computer 20. Each message has a header which describes the content of the message and a body.

At server computer 20 the wire protocol delivers the message to server-side RPC component 26B, which may be called a server stub. Server-side RPC component 26B unpacks the request message and calls the appropriate function(s) in business-logic layer 33. RPC system 26 calls lock and unlock functions which can map directly to the lock and unlock functions of persistent memory manager 32. Server computer 20 then formulates and sends to client computer 12 a reply message.

The header part of each message in the data stream includes the information necessary for RPC system 26 to manage the information exchange. The header contains sequencing information (a marker that indicates the purpose of this information), data length, and content format information.

The body part of each message in the data stream contains the data relevant to the service caller and implementor. The body of a request message includes, and preferably consists of the marshalled function parameters (if any) associated with the request. If there are no parameters, the body of the request is empty. The body of a reply message contains the marshalled result and/or returned parameters. Marshalled means that the parameters have been converted to a form suitable for transmission over RPC system 26. When a marshalled result or parameter has been received then it can be transformed back into its normal memory representation. If an exception occurs on the server, the body of the reply message need only contain a description of the exception.

As shown in FIG. 7, the header portion of all normal requests and replies is preferably in two parts. A first part of the header which may be denoted “header A” contains the bare minimum of information necessary to control the data exchange (flag and length). A second part of the header which may be denoted “header B” contains any additional information required to characterize the request or reply. The separation of the header into two parts permits the second part to be encrypted. This contributes to the security of the link. If the contents of header B could be faked, an intruder would find it easier to subvert the link and construct denial of service attacks, among other things.

The following C++ header file defines a structure which could be used by an RPC system 26 to generate headers of messages according to a currently preferred embodiment of the invention.

// This first part of the header is sent unencrypted and uncompressed. It includes just enough
// data to enable data exchange.
struct RPCHeaderA {
// The first thing in the header is a 4 character string (which is not null terminated) the string
has
// one of the values: ‘RPCb’ for Big Endian (only used for first send from server)
// ‘RPCl’ for Little Endian (only in first send)
// ‘RPCk’ for key return from client (only if encryption is set)
// ‘RPCc’ for a service request from client to server;
// ‘RPCs’ for a result from server to client

static const char RPCBigEndianFlag[] = “RPCb”;
static const char RPCLittleEndianFlag[] = “RPCl”;
static const char RPCKeyFlag[] = “RPCk”;
static const char RPCServiceRequestFlag[] = “RPCc”;
static const char RPCServiceResultFlag[] = “RPCs”;

char rpcMarker[4];
// The header includes length for the data that follows. Note that this is the *transmission*
// length-the ultimate source or destination length may well be different because of
// compression and encryption. The length includes the second part of the header
// (RPCHeaderB)*after* compression and encryption.
// This length does *not* include RPCHeaderA, The “raw”
// uncompressed data length is recorded in: RPCHeaderB::rawLength.

UInt32 xmitLength;

};
// The rest of the protocol header information is encrypted. This makes it difficult for a malicious
// third party to subvert the encrypted exchange of messages by changing the function
selector,
// which would cause the server to call the wrong function. The header is not compressed.
struct RPCHeaderB {
// This is the “raw” (uncompressed) data length. This length includes RPCHeaderB (this struct),
// but not RPCHeaderA. The equivalent compressed length is recorded in
// RPCHeaderA::xmitLength. The raw length is here instead of in RPCHeaderA to prevent
// malicious manipulation of the raw length (from here on, the data is encrypted), which might
// be used to cause buffer overflows.

UInt32 rawLength;

// This is the length after compression, before encryption (encryption may pad out to a multiple
// of a fixed block size).

UInt32 compressedLength;

// The service ID - a unique number indicating what kind of service is expected

UInt16 serviceID;

// The service version: a server has to have a way to decide if it can handle a particular client,
// which may expect an older or newer version of the protocol. Therefore, this could be called
// a protocol version number.

UInt16 service Version;

// Define some values that tell the client what the server did with its request:

static const UIntl1 resultOK = 0; // Service function did its work
static const UInt16 resultException = 1; //exception occurred
static const UInt16 resultTerminate = 2; //Drop this connection

// In a request this variable selects one of the functions that the service provides. In a reply this
// variable assumes one of the three values defined above (resultOK, resultException,
// resultTerminate):

UInt16 serviceFunction;

// Provide some room for expansion. This 16 bit integer is zero in current implementations:

UInt16 serviceFuture;

};
// The rest of the data (function parameters and results) follows the two headers.

In the preferred embodiment of the invention both client-side RPC component 26A and server-side RPC component 26B are implemented as a set of classes. The classes are defined using an IDL (Interface Description Language) which is a small subset of the CORBA IDL. An Interface Definition Language is a language which is used to describe the interface between a program running on one system and a set of functions or subroutines on another system (or in another process).

Providing a RPC interface which is wrapped in a class is a helpful convenience in several ways. It makes for a cleaner implementation because it helps separate RPC service support from server and client stub code. It also helps manage the function and data type name space on client and server.

In the preferred embodiment of the invention RPC system interfaces do not support inheritance or polymorphism. Furthermore, these interfaces do not maintain any state aside from the connection state, which is almost entirely hidden from the caller (client kernel 22B) and callee (business logic layer 33). RPC system 26 does not hold data. A programmer can define types and functions in such an RPC interface but not variables.

RPC system 26 preferably supports a number of data types including common data types: byte, short and long integers (signed and unsigned), booleans, strings, and structs containing scalars and aggregate data types.

From an IDL input that describes the required service interface, a suitable IDL compiler generates the client stubs. No further manual programming is required to generate client-side RPC component 26A. The client can use the generated interface implementation.

Server-side RPC component 26B benefits from the fact that the interface is generated as a class. On the server side, the class generated by the IDL compiler manages the server side of the connection (the server side stubs), but the actual server functions are defined as virtual. Server-side RPC component 26B can then be implemented as a class that inherits from the generated interface class and overrides the functions. The programmer can add any state he or she pleases to the generated interface class and use all the facilities of C++ to support its needs as required.

Although the RPC interfaces are not objects, RPC function parameters can be objects in the sense of C++ classes. For example, externally defined classes which are known as predefined types to the IDL compiler may be C++ classes on the server side, and Java classes on the client side.

The preferred embodiment of the invention uses an IDL which is similar to the Corba RPC IDL. The IDL can be described using a syntax notation that is similar to Extended Backus-Naur Format (EBNF). Table I lists notation which may be used to describe an IDL in practising this invention.

TABLE I
IDL NOTATION

| Symbol | Meaning |
|---|---|
| ::= | Is defined to be |
| \| | Alternatively |
| <text | Nonterminal |
| > | |
| “text” | Literal |
| * | The preceding syntactic unit can be repeated zero or more |
| | times |
| + | The preceding syntactic unit can be repeated one or more |
| | times |
| {} | The enclosed syntactic units are grouped as a single |
| | syntactic unit |
| [] | The enclosed syntactic unit is optional-may occur zero or |
| | one time |

In the grammar that follows, an <identifier> is a legal C++ or Java identifier. No word which is reserved in C++ or Java should be used as an identifier.

<Intertace_dcl> ::=<interface_header> “{” <interface_body>“};”
<interface_header> ::= “interface” <identifier>

service <unsigned_integer_literal>
version <unsigned_integer_literal>
[minimumversion <unsigned_integer_literal>]

<interface_body> ::=<export>*
<export> ::= <constructed_type_spec>“;”

|<op_dcl> “;”

<op_dcl> ::= <op_type_spec> <identifier> <parameter_dcls>
<op_type_spec> ::= <type_spec>

|“void”

<parameter_dcls> ::= “(” <param_dcl>{“,” <param_dcl>}*“)”

|“(”“)”

<param_dcl> ::= <param_attribute> <type_spec> <identifier>
<param_attribute> ::= “in”

|“out”
|“inout”

<type_spec> ::=<base_type_spec>

|<constructed_type_spec>

<base_type_spec> ::= “bool”

|“Slnt8”
|“Ulnt8”
|“Slnt16”
|“Ulnt16”
|“Slnt32”
|“Ulnt32”
|“string”
|“bool”
|“Date”
|“Time”
|“StringVec”
|“Ulnt32Vec”
|“Slnt32Vec”
|“PMMextRef”
|“PMMextRefVec”
|“IntStrVec”
|“RefStrVec”
|“StrStrVec”
|“IntlNtVec”
|“ServiceState”
|“ServiceStateVec”

<constructed_type_spec> ::= <struct_type>

|<enum_type>
|<vector_type>
|<variant_type>

<struct_type> ::= “struct” <identifier> “{” <member_list> “};”
<member_list> ::= <member>+
<member> ::= <type_spec> <identifier> “;”
<enum_type> ::= “enum” <identifier> “{” <identifier> {“,”

<identifier>}* “};”

<vector_type> ::= “vector” <struct_type> <identifier> “:”
<variant_type> := “variant” <identifier> “{” <existing_type> {“”

<existing_type>}*“}”

<existing_type> ::= <base_type_spec>

|<constructed_type_spec>;

The IDL compiler is preferably adapted to permit C++ style comments in an IDL file.

The vector statement allows a programmer to make a vector type from any struct that has been previously defined. In the generated class, this provides an STL vector of the given struct type. A vector can be used in the same manner as any STL vector, with the added benefit that it can also be used as an RPC function parameter.

Variant types let a programmer pass a parameter which is one of a given number of base or constructed types. The vector statement can be used to make a vector of variants.

The following is a sample of an IDL suitable for use in generating software components of RPC system 26.

//Sample service definition. Note that if the minimum version number is
// unspecified, it defaults to the version number.
interface SampleService 42 version 8

minimumversion 6 {

// A struct type
struct SampleStruct {

bool aBoolean;
SInt32 aSigned32BitInteger;

};
// An enumerated type
enum SampleEnum {

firstEnum,
secondEnum

};
// minimal function
void SimpleFunc();
// A slightly more complex function
bool MiddlingFunc(

in SampleStruct aStruct);

// A fancier function
SInt32 FindPeople(

in string nameInitialSubstring,
inout string currentPersonName,
out PMMextRefVec foundPeopleList);

// A vector
vector SampleStruct SampleStructVec;
// A variant
variant SampleVariant

{bool, UInt32, SampleStruct};

};

An IDL compiler suitable for use in creating RPC system 26 can be a very simple program. At a basic level it performs pattern substitution. It takes two input files and generates one output file. A primary input file defines the particular interface using the IDL which is described above. The IDL compiler reads the primary input file, parses it, and retains the information in an internal form. A second input file contains a code skeleton. The skeleton file contains C++ or Java code that is constant for all uses of the RPC interface, together with a number of substitution tokens which specify where to place code that will vary for different specific services. For example, each substitution token may be a string of the form “$TokenName$”.

The IDL compiler reads the skeleton file. All text other than the substitution tokens is copied directly to the output file. When the compiler encounters a substitution token, it writes text to the output file which substitutes for the token. That text is derived from the internal representation of the IDL. Table II lists possible values of TokenName used in a preferred embodiment, together with a description of what the IDL compiler emits for each one.

TABLE II
IDL COMPILER SUBSTITUTIONS

| Token Name | Result |
|---|---|
| ServiceName | The name of the service, i.e. the identifier that follows the |
| | interface reserved word in the IDL |
| ServiceID | The ID of the service, i.e. the unsigned short integer |
| | parameter that follows the service reserved word in the IDL |
| ServiceVersion | The version number of the service, i.e. the unsigned short |
| | integer parameter that follows the version reserved word in |
| | the IDL |
| ServiceMinimumVersion | The minimum version number of the service, i.e. the |
| | unsigned short integer parameter that follows the |
| | minimumversion reserved word in the IDL |
| FunctionSelectors | Emit a C++ enumerated type that provides a unique function |
| | selector value that is passed from the client to the server in a |
| | request to identify which server function should be called |
| Enumerations | Emit the C++ enumerated types that correspond to the |
| | enumerated types defined in the IDL. |
| StructDefinitions | Emit the C++ struct definitions that correspond to the struct |
| | definitions in the IDL. |
| MarshalDeclarations | Declarations of C++ functions that are required to marshal |
| | data whose type was defined in the IDL. |
| ClientMarshalFunctions | Client side C++ functions to marshal data whose type was |
| | defined in the IDL. |
| ServerMarshalFunctions | Server side C++ functions to marshal data whose type was |
| | defined in the IDL. |
| RealFunctionDeclarations | C++ declarations for the service functions. These are the |
| | real, as opposed to virtual, declarations for those functions. |
| VirtualFunctionDeclarations | C++ declarations for the service functions. These are the |
| | virtual, as opposed to real, declarations for those functions. |
| ClientStubs | C++ client stub functions. These functions marshal the in |
| | parameters, send the marshalled data, read the reply, and |
| | unmarshal the result and out parameters. |
| ServerStubDeclarations | Declare the C++ server stub functions. |
| ServerStubs | The actual C++ server stub functions. These functions |
| | unmarshal the in parameters from the client, call the relevant |
| | server function, then marshal the result and the out |
| | parameters and send the reply back to the client. |
| ServerStubSwitches | The C++ switch statement that decides what server side |
| | function to call, given the function selector value (see |
| | FunctionSelectors above). |
| JavaEnumerations | Emit the Java enumerated types that correspond to the |
| | enumerated types defined in the IDL. |
| JavaClientStubDeclarations | Java declarations for the client stub functions. |
| JavaClientStubs | The actual Java client stub functions. These functions |
| | marshal the in parameters, send the marshalled data, read |
| | the reply, and unmarshal the result and out parameters |
| JavaFunctionSelectors | Emit a Java enumerated type that provides a unique function |
| | selector value that is passed from the client to the server in a |
| | request to identify which server function should be called. |

A set of standard skeleton files may be provided to programmers to facilitate the generation of RPC systems 26. Skeleton files may be provided for each of the following purposes:

Generate the header file for the C++ client side stub class;

Generate the code file for the C++ client side stubs;

Generate the Java interface file for the Java client stubs;

Generate the Java code for the Java client;

Generate the C++ server stub class header file. Note that this is an intermediate class—the actual server side implementation class inherits from this one; and,

Generate the C++ server stub class code (intermediate class).

Given a suitable IDL compiler and a set of skeleton files a programmer can create the software for implementing RPC system 26 in a straightforward manner. After defining the required interface in IDL, the programmer may, for example, begin by building the server side of an RPC connection. This can be done by using the IDL compiler to generate the server side stubs from the IDL and appropriate skeleton files. In the currently preferred embodiment of the invention this involves generating a C++ header file and a file containing C++ server stub class code. These files together define all the actual server functions as virtual. The programmer can then create a class that inherits from the created files. In this class, the programmer can override all the virtual server functions and actually implement them.

The combination of the class produced by the IDL compiler and from the parent class RPCServerBase provides functions which do all the work of receiving parameters by way of a communication link passing them to functions of business logic layer 33. The same functions can take a result and returned parameter values (or an exception generated in business logic layer 33) and pass them back to the client.

A programmer must also write the code that instantiates the class in response to a connection request. Various suitable ways to do this are described in “Unix Network Programming, Volume 2, Second Edition”, by W. R. Stevens (ISBN 0-13-490012-X).

The programmer can create code for implementing client-side RPC component 26A in a straightforward manner as described above. C++ code produced by IDL compiler can be compiled and linked to the server-side kernel 22B. Java clients are supported by a Java implementation of the RPC interface. This includes a Java version of the code to manage RPC data transfers, with compression and encryption.

The following is an example which illustrates a typical pattern of client side use of an RPC interface written in the C++ language. This example assumes that the interface has a client side called “ProofClient”.

```
#include “ProofClient.h”
string hostName = “www.sportica.com”;
SInt32 hostPort = 32;
ProofClient* pClient = new ProofClient;
try {
  pClient.ConnectToHost(hostName, hostPort);
}
catch (...) {
  // Here we handle a connection failure
}
// Make calls to the service functions, which will look like:
// try{aResult = pClient->ProofFunc(aParameter);}catch(...) {}
// When done:
delete pClient; // This will close the connection
pClient = NULL;
```

Those skilled in the art will appreciate the following points:

Allocation (new) is separated from initialization (ConnectToHost) because the connection process may throw an exception;

Calls to the service functions should be contained in a try-catch block because they, too, may throw exceptions. Some of those exceptions may relate to the connection, others to conditions internal to the server.

The connection can be closed by deleting the RPC object.

The ProofClient class inherits from class RPCClientBase, which provides all the client side connection state and common behaviour.

In order to provide good responsiveness, RPC system 26 should properly handle errors that may occur in the transmission of data between client computer 12 and server computer 20. Errors can and do arise because the connection may become temporarily unavailable or the connection may “hang”. Where data is transmitted between client computer 12 and server computer 20 on a robust transport layer such as, for example, TCP/IP (Transmission Control Protocol/Internet Protocol) the transport layer will attempt to correct many transmission problems (such as packet loss and data errors). Problems that the transport layer cannot correct are typically manifested as either a hang or a drop. An application that uses an RPC system must be equipped to deal with these errors.

RPC system 26 should report errors of at least the following types:

Connection dropped—the TCP/IP connection to the server has been lost;

Data changed—one or more of the data items referred to in the transaction has been modified since the client acquired the data reference used in the transaction;

Data deleted—one or more of the data items referred to in the transaction has been deleted since the client acquired the data reference used in the transaction;

Other errors—these are all the other errors that might occur in a normal data management service, such as data validity errors or internal logic errors.

RPC system 26 can preferably report these errors by throwing an exception of type RPCException. That class includes an enumerated type which distinguishes among the errors listed above. Every call to RPC transaction function must be prepared to deal with errors of these types.

Preferably software client component 22 includes a canonical event routine handling pattern which includes a try-catch block to deal with these expected errors when they occur. A try-catch block has the general structure:

try {tryStatements}

catch(exception){catchStatements}

finally {finallyStatements}.

The catch part of the try-catch block includes statements which deal with the errors. These statements may use the exception type to distinguish between errors of different types.

In a reply, the body may contain one or more of three things:

1. If the function has a result, the marshalled form of the result variable;

2. If there are out parameters (those that go from server to client), the marshalled form of the parameters;

3. If there was an exception, the marshalled form of the exception—any result or parameters are discarded.

In a reply, the flag field of header A contains “RPCs” (the ‘s’ stands for “server”).

In the preferred embodiment of the invention, server software component 30 determines whether the connection is to be encrypted or not, compressed or not, little-endian or big-endian. It is the responsibility of client software component 22 react to these choices in one of two ways: either adapt to them or refuse to complete the connection. This approach minimizes load on server computer 20. In many cases server computer 20 will be a performance bottleneck.

Client computers 12 may be of diverse different types. Some may have processors which represent numbers in a big-endian format. Other client computers 12 may represent numbers in a little-endian format. The Java virtual machine and the Java binary file format are big-endian. Java clients are big-endian, no matter what system they are running on. In most cases it is preferable to do any necessary byte-swapping at the client so that data is transmitted to the server in the format used by the server.

A service session is made up by a series of transactions between a client computer 12 and a server computer 20. A session begins with the first transaction after a TCP/IP link across network 14 is established, and ends with the last transaction before the link is dropped. A session has two phases: startup and transactions. The startup phase occurs immediately after the communications link is established. The transaction phase occupies the rest of the session.

The startup phase is very simple. It is the only part of the conversation between client and server that is server-driven. The server drives it because the server determines the link parameters and the client has to adapt. Upon a communications link being established, server 20 generates an instance of the server-side RPC component 26B. This component sends a request to client RPC component 26A. Client-side RPC component 26A must read this request immediately after the connection is established. Furthermore, this first request is unlike subsequent requests in that it only has header A, not header B. This is because this first request establishes whether or not the link is to be encrypted and/or compressed. Header B can only be properly interpreted when it is known whether the link is encrypted and/or compressed.

In the currently preferred embodiment of the invention the startup phase request comprises:

Header A with flag ‘RPCb’ for a big endian connection, or ‘RPCl’ for a little-endian connection and Service ID (unsigned 16 bit integer);

A service version number (unsigned 16 bit integer);

A Minimum service version number (the lowest version number the server is willing to deal with; frequently the same as the basic version number) (unsigned 16 bit integer);

A 16 bit unsigned integer for future use that is currently unused and always zero;

A boolean expression that is true if this link is to be compressed;

A boolean expression that is true if this link is to be encrypted;

Two unused boolean expressions for future use, currently always false;

If the link is to be encrypted a string representing the server's exchange key number. For example, this string may contain the server's Diffie-Hellman exchange key number in base 36 (‘0’ through‘9’, ‘A’ through ‘Z’).

Another difference between the startup phase and the transaction phase is that, in the startup transaction, the reply (which in this case goes from client to server) is conditional. The startup reply only contains the client part of the Diffie-Hellman key exchange, and it is unnecessary if the link is not to be encrypted. If the link is to be encrypted, the client returns a reply in the following format:

Header A with flag ‘RPCk’.

A string representing the client's exchange key number, for example, the client's Diffie-Hellman exchange key number in base 36 (‘0’ through‘9’, ‘A’ through ‘Z’).

The transaction phase consists of a series of RPC transactions. Each transaction consists of a service request sent to the server by the client, followed by a service reply sent from the server to the client.

In order to obtain maximum communication performance it is preferable that RPC system 26 supports data compression. Suitable compression may be provided by incorporating software components from a commercial library of compression software tools such as ZLIB™. Zlib is convenient because it is currently available for both Java and C++. Information on zlib, is currently available at the following web site: http://www.info-zip.org/pub/infozip/zlib.

Since some applications may handle sensitive data, RPC system 26 should provide secure communications between client computers 12 and server computer 20. RPC system 26 should support encryption. For example, RPC system 26 may implement the Diffie-Hellman algorithm for key exchange, with a 1024-bit exchange key, resulting in a secret key for use in session encryption. The secret key may be, for example, 128 bits 192 bits or 256 bits. Information on the Diffie-Hellman algorithm is currently available in the documentation available on the Internet at the web site: http://www.fags.org/rfcs/rfc2631.html.

Once a key has been exchanged, information may be encrypted by any suitable encryption algorithm. for example, RPC system 26 may use the high performance, chaining block cipher algorithm called TwoFish available from Counterpane Internet Security, Inc. of San Jose, Calif. Implementations of TwoFish are available for both C++ and Java. More information about TwoFish is currently available in the documentation available on the Internet at the web site: http://www.counterpane.com/twofish.html.

Software Client Component

Software client component 22 preferably handles GUI 22A and communication with server computer 20 and, as nearly as possible, server computer 20 does everything else. There will inevitably be some data cached in software client component 22. Primarily, that data will be present in visible controls, and, at least in the case of certain lists, in data structures associated with the controls.

In the presence of other users who might change data on server computer 20 this can cause a problem since the “real” data (kept by server computer 20) may not match the values visible in the user interface 22A on a given client computer 12. This problem can be managed with the use of the data change and deletion exceptions generated in response to the use of external data references as discussed above.

Consider, for example, a typical case: software client component 22 uses a search transaction that returns a list of references to people, each reference associated with a person's name. Software client component 22 uses the names to populate a list box in GUI 22A and keeps the references so that it can look up data associated with any one of the names. Another user then deletes one of the people in the retained list. Subsequent to the deletion the user executes a user transaction which causes software client component 22 to request data for the deleted person. In this case the following sequence of events occurs:

1. Software client component 22 issues a request for data for the deleted person;

2. Software server component 30 generates an exception in response to the request (because the data reference points to data that is no longer there);

3. Software client component 22 receives the exception, and does three things: it displays an error message such as “Another user has recently deleted that person”, it deletes the person from its local list, and redisplays the list box.

Consider another example case. In this example, a user of software client component 22 is modifying data fields for a person. The user selects a person by clicking on a person's name in a person list. In response, software client component 22 sends a request to software server component 30 for data fields for the selected person and fills visual control fields in GUI 22A with the appropriate strings. The user modifies one or more of the values. Suppose that another user has modified data fields for the same user in the meantime. Software client component 22 attempts to send the modified fields back to software server component 30 by forwarding a change data message which includes an external reference identifying the person. Software server component 30 detects that the person's data has changed since the external reference was issued by comparing the change count in the external reference received from software client component 22 with the current change count which is stored in data reference vector 37. Software server component 30 generates a data-changed exception which it forwards to software client component 22. When software client component 22 fields the exception it displays an error message such as “Another user has changed data for this person while you were making your changes. Please check the data and, if necessary, make your changes again.”. Software client component 22 also refreshes the contents of the visual control fields with the current values and updates its external reference to the person.

Client user interface 22A may include both lists and single datum user controls. Lists are typically lists of names that refer to data held at server computer 20. The names may be, for example, names of people or groups or projects—whatever the server manages. Usually, the client will keep a persistent memory manager external reference to each item in the list. Software client component 22 can use the reference associated with a given name in a list order to fetch or modify data associated with that name.

Single datum controls are things like text labels (for display), text edit boxes (in edit dialog boxes), radio buttons, check boxes, and pop-up menus. Each one of these controls will, typically hold a copy of a datum from the server.

Software client component 22 can use various data types which are available on RPC system 26 for communicating with server computer 20. For example:

Vectors of integers can be used as field selectors. An enumerated type defined in the RPC interface IDL can be used to select desired fields to be returned by the server by making entries in an integer vector from the enumeration and then passing the vector to the server.

String vectors are useful for field lists, etc.

Integer-string pair vectors may be returned by the server in response to a request for a set of field values specified by an integer vector of field selector values. In each integer-string pair, the integer is the selector value for one of the requested fields and the string is the corresponding datum, expressed as a string.

Reference-string pair vectors may be returned by the server in response to a request for a list of named server data items. In each reference-string pair, the reference is the external data reference to the datum whose name is expressed in the corresponding string.

When it is constructing a data reference list, software client component 22 typically fills the list initially as a result of a find or search operation. Software client component 22 typically proceeds to select the first entry in the fetched list and take whatever action that implies (usually filling visible fields in an associated panel). Software client component 22 provides a location to store the external data reference associated with each string in a list.

After a list has been constructed, it is necessary to maintain the list as various aspects of its state may change. If a user of the software client component 22 deletes a datum that is referred to in the list, the reference in the list should be deleted. Usually, after the local list entry is deleted, software client component 22 selects the next item in the list (if there is one).

If a different client deletes a datum which is referred to in a list, software client component 22 will receive a data-deleted exception when it attempts to use the associated external reference. This will typically occur when a list item is selected and software client component 22 attempts to fetch field values corresponding to the list item. Software client component 22 includes a handler for that exception which, among its other duties (such as presenting an appropriate dialogue to inform the user that the data has been deleted), should delete the local entry in the list and select the next item.

An operation executed by a user that creates a new datum of the kind referred to by a visible list should normally add an appropriate entry to the list (in the appropriate position) and select it. New data created by users at other client computers 12 will not appear unless a new search or find operation is done.

Data modification operations which make changes to a name in a list should change the name string in the visible list, and alter its position in the list if required. Software client component 22 should modify any visible lists in the same manner if it is informed that another user has made a change to a name in such a list. Transactions which are driven by the external reference from the list item should return the current value of the item name so that software client component 22 can identify such changes. When it receives a return from such a transaction, software client component should check the name returned by server computer 20 and update the name if it has changed. Software server component 22 should also display a dialog to inform the user of the name change.

External references to data managed by persistent memory manager 32 track changes to the datum. Server functions can be written to use or ignore that change information. Typically, the change information is ignored on fetch but used on store. When an instance of software client component 22 fetches data (usually to fill visible controls in a panel), it is not important if the data has changed since software client component 22 originally acquired the reference and put it in the list. Server transactions that are used to fill fields for display on a client computer 12 do not need to throw data-changed exceptions. Such server transactions should, however, return the current values of the data indicated by the external reference and the item name in order to support list maintenance in the client.

In many applications software client component 22 will allow users to select items, such as the names of people, from lists and then display data values corresponding to the selected item as a related set in a panel. In such cases, software client component 22 includes a function that, upon selection of an item, sends a request to server computer 20 for the required set of values. The request uses an external data reference to identify the datum that provides access to all those fields. The data reference will usually have been found in response to a click in a list which names the items and has stored external references associated with each item. The transaction may operate, for example, as indicated by the following C++-like pseudo code.

// Call a service routine to get the item reference for the currently selected item
PMMReference itemRef = GetSelectedItemReference();
// Create a variable to receive the current value of the item name
string itemName;
// Pass in an integer vector of field selectors to tell the transaction which ones are wanted
IntV fieldSelectors;
// Create a place for the transaction to return the field values which were requested
IntStrV field Values
try{

// The transaction will return the current value of the item ref as well as the
// current item name and the field value vector
GetFieldsTransaction (itemRef, fieldSelectors,

itemName, field Values);

{
catch (){

switch (){

case data-deleted:

// Call service routine to display error dialog, delete local list entry
and select next entry return;
break;

case some-other-error:

// Handle some other error
return;
break;

}

}
// Call service routine to update item reference and item name (if need be), then put field
// values into panel controls

When a user edits data fields there is the potential for data conflicts to occur since two users might try to edit the same fields at the same time. In preferred embodiments of the invention software client component 22 provides a window which presents data values in a display-only mode, and provides a button or other control which can be used to enter a mode which permits the values of displayed fields to be edited. Activating the edit button causes software client component 22 to present a separate modal dialogue which presents the data values in editable controls. That dialog may include the usual OK and Cancel buttons to accept or discard any changes made while the dialog is present. The following pseudo-code provides an example method for handling the events which occurs when the OK button (or similar control) is invoked to indicate that the user is satisfied with the edited data.

// Call a service routine to get the item reference for the item being edited
PMMReference itemRef = GetEditItemReference();
// Create a variable to receive the current value of the item name, because that might change
// as a consequence of our edit actions
string newItemName;
// place the new field values in a vector of integer-string pairs
IntStrV field Values
bool tryAgain = true;
while (tryAgain)

try {

SetNewFieldValuesFromEditControls(

newField Values);

// The transaction will return the current value of the item ref as well

as the current item

// name, after it puts the new values in the store

SetFieldsTransaction(itemRef, itemName,

newField Values);

// We succeeded, so we don't need to try again
tryAgain = false;

}
catch (){

switch(){

case data-changed:

// Some other user has changed the data. Show error dialog, call
// transaction to get current field values, go around the loop again to
// allow user to edit current values
break;

case data-deleted:

// Show error dialogue, delete local list entry, and select next entry
return;
break;

case some-other-error:
// Handle some other error
return;
break;

}

}

}
// Call service routine to update item reference and item name (if need be), then put the new
// values into the panel controls that are visible in the base window from which the edit
// originated

There are several possible situations which could occur as a result of different users attempting to edit the same data at more or less the same time. In the discussion that follows, changes made by a first user of a first client computer 12 are referred to as local changes while changes made by users of other client computers 12 are referred to as remote changes.

Consider the time sequence of a first user's interaction with the data:

Step 1. The user selects an item in a list to display related fields in a panel (for example by clicking on the item).

Step 2. The user clicks on the Edit button in the display panel to bring up the edit dialog.

Step 3. The user changes field values in the edit dialog.

Step 4. The user presses OK to send the changes to server computer 20.

Remote changes which occur before step 1 can generally be ignored because step 1 will still present to the user up-to-date data. It may be desirable to flag changes in any names in the list. Consider the following scenario:

1. The first user performs a search or find operation to get a list of people. The list includes a person named “Fred Jones”.

2. After the list is delivered to the first user's client computer 12, there is a remote change to Fred Jones.

3. The first user selects Fred Jones in the list. It does not matter whether or not someone else has changed data associated with Fred Jones because the first user has not yet viewed that data. Note however, that it does matter if the remote change altered Fred Jones' name (e.g. the name has changed to now Sam Jones). This can be handled as discussed above.

There may be remote changes between steps 1 and 2. Software client component 22 could announce such changes to a user, but in order to do so it would have to refetch the values in order to fill the fields in the edit dialogue. This will usually be undesirable because the benefit will generally be outweighed by added complexity.

Remote changes may occur between steps 1 and 4. If this occurs then corrective action should be taken. It is not generally desirable to permit users to make changes based on obsolete data. The transaction that attempts to store values for data in server computer 20 should raise an exception if the data has changed. The external reference forwarded by software client component 22 to indicate what data is to be updated will have been obtained during step 1 when the data for displaying in the base window were fetched.

If server computer 20 responds to a change request with an indication that a remote change has been made to the affected data then software client component 22 may proceed as follows:

1. Display an error dialog which explains that someone else has changed the data;

2. Fetch the new (current values) values for the data as modified by the remote change;

3. Update the display pane with the new values;

4. Redisplay the edit dialogue with the new values and permit the user to make changes again, or not, as the user chooses.

While software client component 22 could provide a separate function for requesting each datum or set of data from server computer 20, preferably software client component 20 provides a more general interface. For example, an application in which GUI 22A provides an ID tab and an address tab which can be selected to provide corresponding information associated with a selected person may provide two different functions, each custom crafted to retrieve the data needed for one of the two tabs. Each function could take the key of a person in the database and return the data needed by its tab. It is preferable that software client component 22 provide a single function which accepts a list of desired fields along with a key identifying a person. The single function can then return values for all of the requested fields. The support code for each of the two tabs can then use a particular instantiation of the data transaction function which retrieves the data required by the tab. Preferably each user transaction (i.e. each transaction between the user and GUI 22A intended to affect the state of data held by server computer 20) maps to an instantiation of a data transaction function.

Report Generation

As noted above, it is desirable to keep data transactions very short. If reports were generated at server computer 20 then server 20 could become unresponsive to other users while preparing a report for one user. Report generation in the server would involve long transactions. In the preferred embodiment of the invention, reports are formatted and prepared at client computers 12. In this preferred embodiment of the invention, responses to user GUI interactions can be characterized as interactive (and require very fast response) whereas reports can be considered to be batch jobs for which slower response is acceptable.

Each report typically comprises a list of items or people along with a few data fields associated with each item or person on the list. For each type of report server computer 20 preferably has stored one or more report definitions. The report definitions specify the data fields used by each report, the search criteria used to select the people or groups being reported on, and the order in which the selected people or groups are to be presented. Server computer 20 preferably also stores one or more report formats. The report formats include layout information as well as the field grouping and sequencing information which indicate how the report will be presented to a user.

In the preferred embodiment of the invention, reports are prepared by the following process. First, a reporting module 66 in software client component 22 acquires a report definition and layout from server computer 20. Reporting module 66 may optionally permit the user to modify the report definition and layout. Next, the reporting module 66 generates a request for the list or group of items (or people) to be covered by the report. This request is sent to server computer 20. The request is based on the search and ordering criteria in the report definition. Reporting module 66 receives the list and then iterates through each item in the list, requesting the required fields from server computer 20 and adding data received from server 20 in response to such requests to a report.

Preferably reporting module 66 supports rendering reports in ways suitable for displaying on a computer screen; printing on a printer associated with client computer 12; or writing to a file on client computer 12. Rendering software capable of performing these functions is commercially available.

Configuration Server

In a case where there are multiple client applications and multiple data servers there is a need for a mechanism to permit a client application find the right data server. In general it is desirable to permit the servers to be moved. Embodiments of the invention which have multiple data servers preferably include a configuration server 62 (FIG. 1). Each data server (multiple data servers may be hosted on a single server computer system 20) registers itself with configuration server 62. Configuration server 62 maintains a central directory of data servers.

During the startup phase of a session software client component 20 connects to configuration server 62 and receives a list of available data servers. For example, in an application which permits users to store and maintain information regarding participants in sports leagues, the list may be a list of data servers which service different sports leagues. The network address of configuration server 62 is known to software client component 20 in advance. When a user selects a particular data server then the configuration server sends a message to software client component 20 which includes a network address for the selected data server.

Configuration server 62 may comprise a single process running on a single system. Data server registrations and de-registrations will not typically occur very frequently. Most of the load on configuration server 62 will be servicing client requests for the location of the right data server. Those transactions will typically be small, and they will only happen at the beginning of each session. Even if as many as 100,000 sessions are initialized per hour, the transaction rate at configuration server 62 will average to 28 small transactions per second.

Log Server

In a system which is used commercially it is generally desirable to keep significant amounts of usage and state change data. This data can be used for financial purposes to bill for use and keep track of use. The data can also be used to determine what users are responsible for what actions. This is important for keeping users accountable for their actions. Historical usage data is also important for capacity planning and business planning. Technical troubleshooting is also facilitated by an audit trail which can explain the circumstances under which any problems occurred.

Since usage and state change data can be voluminous it is preferable to provide a log server 64 which provides a centralized repository for such data. Log server 64 periodically creates a new log file and archives older log data. Suitable software and hardware for providing a log server 64 is commercially available and is well understood to those skilled in the art.

Example System

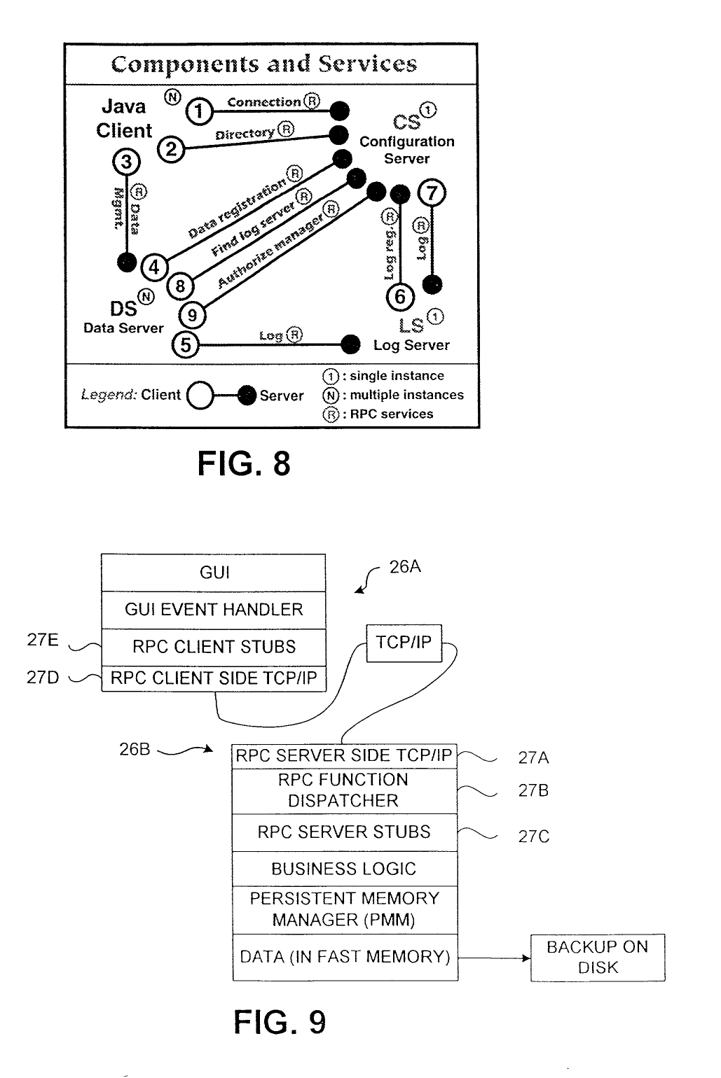

FIG. 8 shows schematically a system 10 according to a currently preferred embodiment of the invention. Each service is provided by a related set of functions which is available by way of an RPC connection. A connection service 71 can be a very simple service. Software client component 22 uses this service to identify itself to configuration server 62 and to learn from configuration server 62 where to find directory service 72. Preferably connection service 71 is very simple so that it will not need to be changed except in an upward-compatible way. This is so that old versions of software client component 22 can always get an intelligent message rather than a crash or a hang when they attempt to invoke connection service 71.

Software client component 22 uses directory service 72 to obtain a list of available data servers, or a list of information bases covered by available data servers (for example, the list could contain the names of sports associations which have data in data servers known to directory service 72). One data server could manage more than one information base. For example the data server could manage data for more than one association. In response to a selection of an available data server or information base, directory service 72 tells software client component 22 where to find the data server. This service could be provided on the same server computer that offers connection service 71 or a different server computer.

Data and management service 73 provides the API (Application Programming Interface) which defines the data storage and data logic environment for the distributed application provided by system 10. The other services support this service. The “management” functions referred to are preferably only available to selected users who have been given rights to manage system 10.

Data server registration service 74 permits a data server to inform configuration server 62 where it is and what information base(s) it manages. Data registration service 74 is preferably a dynamic service. The information bases covered by particular data servers may change over time. Data servers may even be taken off-line.

Log services 75 and 77 log messages reflecting changes in the state of the data server(s) and configuration server 62 respectively.

Log server registration service 76 tells configuration server 62 where to find log server 64.

Find log server service 78 is a service provided by configuration server 62 which provides information regarding the network location of log server 64 so that information can be sent to log server 64.

Authorization manager service 79 registers a unique key for a user with configuration server 62. If and when the user attempts to administer a particular data server, the data server passes the user's ID and the key to configuration server 62 to validate the privileged access.

Preferred Design Philosophy

This invention was motivated by the need for a way to make distributed applications which provide user experiences as similar to the user experiences provided by good single-user, local applications. The software and hardware components described above can be used to accomplish this goal. However, they can also be used in ways which will not perform optimally. A client application will only feel like a single user application if constraints on the communications link and the server are carefully controlled. Keeping typical server interactions shorter in duration than one second is a feasible goal.

Server data is not typically kept in RAM as it is in the persistent memory manager 32 of this invention. Keeping the data in RAM brings two advantages: high performance and flexible access to the data. Access to data in RAM, whether for reading or writing, is typically over 10 times faster than access to the same data on disk. When the data is in RAM one can readily access data structures, lists, and vectors in a manner which is not readily possible when the data is stored in a disk-based relational database. When the data is in RAM it is also practical to lock the whole database for every transaction.

For best client interactive performance it is preferred that one client interface action maps to one RPC transaction, and that maps to one persistent memory manager transaction (which will typically involve multiple persistent memory manager method calls). The persistent memory transaction should be structured in a manner which permits it to be completed very quickly.

As the speed bottleneck in distributed applications is typically the communication link which joins the client and server, to obtain the best performance one should use the minimum number of RPC transactions. Ideally there should be one RPC transaction per user interaction and one data transaction per RPC transaction. Furthermore, the messages in each RPC transaction should be no longer than necessary. This can be accomplished by compressing data and sending only the necessary data. All the formatting logic and field labels are in software client component 22. RPC transaction messages only need to carry variable content.

To obtain the maximum advantage from use of this invention one should keep the system as simple as possible and be willing to work within constraints. The data should all fit in the RAM available on server computer 20. Transactions must use no more than the bandwidth available. Simple data structures and scalar variables should be used to express solutions.

As will be apparent to those skilled in the art in the light of the foregoing disclosure, many alterations and modifications are possible in the practice of this invention without departing from the spirit or scope thereof. Those skilled in the art will realize that the specific descriptions of RPC system 26 and persistent memory manager 32 which are described above are given by way of example. RPC systems or persistent memory managers which come within the scope of the invention could be implemented in other ways, for example, using different programming languages.

Other variations are possible. For example:

While server computer 20 and client computer 12 have both been referred to as computers, either could be a system of cooperating computers.

While persistent memory manager 32 and RPC system 26 have been described as cooperating together, either of these systems has application in other contexts. RPC system 26 could be used in an entirely different server environment where its lightweight but effective approach to data transfer and encryption can be effectively used.

Although it is not required in the preferred embodiment of the invention, the IDL and supporting code could readily be extended to allow programmers to specify an interface with read and write locks.

While TCP/IP is a preferred protocol for carrying requests and replies between server computer 20 and client computers 12 other suitable protocols now available or developed in the future could also be used.

Accordingly, the scope of the invention is to be construed in accordance with the substance defined by the following claims.

What is claimed is:

1. A method for generating a report at a client computer based on data resident at a server computer, the method comprising, at a client computer:
a) obtaining from a server computer by way of a remote procedure call a list of items to be included in a report, the list including a reference associated with each of the items;
b) for each of the items in the list, generating a request for data associated with the item, the request including the reference associated with the item;
c) forwarding the request to the server computer by way of a remote procedure call;
d) receiving from the server computer the requested data associated with the item;
e) after receiving the requested data serially repeating (b), (c) and (d) for subsequent items in the list; and,
f) rendering a report based on the requested data.

2. The method of claim 1 comprising, prior to first generating a request for data associated with the item, requesting from the server computer, and obtaining a report definition, the report definition including an identification of one or more specific data to be requested for each item, wherein generating a request for data associated with the item comprises generating a request for the one or more specific data.

3. The method of claim 1 comprising, prior to obtaining the list of items, requesting from the server computer, and obtaining a report definition, the report definition including a search criteria wherein obtaining the list of items comprises requesting from the serer computer a list of items which match the search criteria.

4. The method of claim 3 wherein the report definition comprises an order for presentation of the items in the list and obtaining the list of items comprises requesting from the server computer a list of items presented in the order.

5. The method of claim 3 wherein the report definition includes an identification of one or more specific data to be requested for each item, wherein generating a request for data associated with the item comprises generating a request for the one or more specific data.

6. The method of claim 1 comprising requesting from the server computer and obtaining a report format, wherein rendering the report is performed in accordance with the report format.

7. A method for making data available to users at a plurality of distributed network-connected user computer systems, the method comprising:
a) maintaining entirely in a high-speed memory of a server computer a data store comprising a data heap containing a number of data and a data reference vector comprising a plurality of records, each record corresponding to a datum in the data heap;
b) receiving at the server computer a request for data, the request comprising a reference corresponding to a record in the data reference vector;
c) locking the data store;
d) based on the record in the data reference vector corresponding to the reference, retrieving the requested data from the data store;
e) unlocking the data store; and,
f) forwarding the requested data to a client computer system.

8. The method of claim 7 wherein forwarding the requested data to a client computer system comprises forwarding the requested data by way of a remote procedure call.

9. The method of claim 7 wherein the reference comprises an offset from a head of the data reference vector.

10. The method of claim 7 wherein each record in the data reference vector comprises a change value for the corresponding datum and the method comprises changing the change value each time the corresponding datum is altered.

11. The method of claim 10 wherein the reference comprises a change value and the method comprises comparing the reference change value to the data reference vector change value and generating an exception if the reference change value does not match the data reference vector change value.

12. The method of claim 7 wherein each record in the data reference vector comprises a uniqueness value and the method comprises changing the uniqueness value each time the record is assigned to a different datum.

13. The method of claim 12 wherein the reference comprises a uniqueness value and the method comprises comparing the reference uniqueness value to the data reference vector uniqueness value and generating an exception if the reference uniqueness value does not match the data reference vector uniqueness value.

14. The method of claim 7 wherein each record in the data reference vector comprises a data kind value and the method comprises setting the data ind value to match a data type of the corresponding datum.

15. The method of claim 14 wherein the reference comprises a data kind value and the method comprises comparing the reference data kind value to the data reference vector data kind value and generating an exception if the reference data kind value does not match the data reference vector data kind value.

16. The method of claim 7 comprising periodically backing up changes in the data store to a slower storage medium.

17. The method of claim 16 comprising periodically backing up the entire data store to the slower storage medium.

18. The method of claim 8 wherein the remote procedure call passes object parameters.

19. The method of claim 8 wherein forwarding the requested data to a client computer system comprises generating a reply message, the reply message comprising a header and a body, the header comprising a first part and a second part, the first part of the header comprising a flag and a length, wherein the method comprises encrypting the second part of the header and the body of the reply message before forwarding the reply message to the client computer system.

20. The method of claim 19 comprising compressing the body of the reply message before forwarding the reply message to the client computer system.

21. A method for making data available to users at a plurality of distributed network-connected user computer systems, the method comprising:
a) maintaining entirely in a high-speed memory of a server computer a data store;
b) establishing a remote procedure call connection between the server computer and a client computer;
c) receiving by way of the remote procedure call connection a request for data from the data store;
c) locking the data store;
d) based on the request, retrieving the requested data from the data store;
e) unlocking the data store; and,
f) forwarding the requested data to the client computer system by way of the remote procedure call connection.

22. A computer programmed to implement a method according to claim 1.

23. A program product comprising a medium carrying computer-readable signals, the signals comprising instructions which, when executed by a computer processor cause the computer processor to execute a method according to claim 1.

24. A memory-resident data structure as shown in FIG. 3.
